(19) United States
(12) Patent Application Publication
(10) Pub. No.: US 2011/0091691 A1
(43) Pub. Date: Apr. 21, 2011

(54) Multiple layer holographic metal flake film and method of manufacturing the same

(75) Inventor: Kurt B. Gundlach, Warren, MA (US)

(73) Assignee: Vacumet Corp.

(21) Appl. No.: 12/589,032

(22) Filed: Oct. 16, 2009

(51) Int. Cl. B32B 3/30; B05D 3/12

(52) U.S. Cl. 428/172; 427/209

(57) ABSTRACT

A metal flake forming film assembly comprising a base material having a first surface and a second surface. A first coating is applied to the first surface of the base material. A first micro embossing is impressed into the first coating on the first surface of the base material. A first layer of vacuum deposited metal covers the first coating of the first surface of the base material and the micro embossing that is impressed into the surface of the first coating. A second coating is applied to the first layer of vacuum deposited metal. A second micro embossing is impressed into the second coating on the first surface of the base material. A second layer of vacuum deposited metal covers the second coating of the first surface of the base material and the associated second micro embossing. The second micro embossing does not adversely affect or alter the first micro embossing impressed into the first coating on the first surface. The resulting flakes may further be encapsulated in the coating. A method of manufacturing is likewise disclosed.

### BACKGROUND OF THE DISCLOSURE

1. Field of the Disclosure

The disclosure relates in general to films and methods for making metal flakes, and more particularly, to a metal flake film and method of manufacturing the same.

The present disclosure sets forth a process and film wherein multiple layers of micro embossed metallized layers can be formed on a single base material (i.e., film).

2. Background Art

The use of metal flakes in various products has been known for a number of years. The metal flakes, typically having size ranges between 5 microns and 200 microns are utilized in metallic paints (for automotive applications, for example), as well as in applications in the cosmetics industry (nail polish, for example) as well as in metallic inks. Such metal flakes can be created in a number of different manners.

In many instances, a micro embossing is impressed into the surface. Such a micro embossing yields a diffraction grating when viewed in visible light at a number of different angles (often referred to as holographic metal flakes). Such metal flakes have a number of different uses in industry.

To manufacture such micro embossed metal flakes, a base film is typically coated with a polymer. The polymer coating is then impressed with a micro embossing. Finally, a metallized layer is vacuum deposited upon the micro embossings of the polymer coating. The film is typically formed into a roll and transported for processing.

During the processing, the film is introduced into a solvent which dissolves the coating to form metal flakes. In certain instances, the film can be reused (i.e., recoated, embossed and re-metallized) whereas in other instances, it is discarded.

One disadvantage of such a system is that a roll of film has a single metallized layer which substantially matches the surface area of the film. Increasing the yield of a single roll of film beyond the surface area of the film greatly reduces the costs which are incurred through handling, shipping, transportation and removal with solvent.

It is an object of the present invention to increase the yield of micro embossed metal flakes for a base material of film (i.e., a roll of film).

It is another object of the present invention to provide for multiple metallized layers on a single layer of base material (i.e., multiple metallized layers on a single roll of film).

It is another object of the invention to decrease the cost of producing micro embossed metal flakes.

These objects as well as other objects of the present invention will become apparent in light of the present specification, claims, and drawings.

### SUMMARY OF THE DISCLOSURE

The disclosure is directed to a metal flake forming assembly (i.e., film structure) as well as a method of manufacturing metal flake film. With respect to the manufacture of metal flake film, the method comprises the steps of first providing a base material that has a first surface and a second surface. Once provided, a first coating is applied to the first surface of the base material. Next, the surface of the coating is impressed with a first micro embossing. Subsequently, a first layer of metal is vacuum deposited upon the first coating applied to the first surface having the micro embossing. This process is then repeated by applying a second coating upon the first layer of metal. Then, a second micro embossing is impressed into the second coating. Subsequently, a second layer of metal is vacuum deposited upon the second coating applied to the first layer of metal.

In a preferred embodiment, the step of impressing the second micro embossing leaves the first micro embossing substantially unaffected and unaltered. Thus, adding layers does not adversely affect or otherwise compromise the first embossing.

In a preferred embodiment, the steps of applying, impressing and vacuum depositing are repeated at least once to form additional layers of coating and metal successively and sequentially. The number of layers that is formed is limited primarily by an economic evaluation. For example, the value of any process waste or losses increases rapidly as the number of layers increases.

In another preferred embodiment, the method further contemplates the placement of micro embossings and metallized surfaces on the second surface of the base material. In particular, the method further comprises the steps of applying a first coating to the second surface of the base material. Next, the step of impressing a micro embossing into the first coating on the second surface of the base material is completed. Then, the step of vacuum depositing a first layer of metal upon the first coating applied to the second surface having the micro embossing is completed.

In one such embodiment, a second set of layers may be applied to the second surface of the base material. Specifically, such a method comprises the step of first applying a second coating to the first layer of metal on the second surface of the base material. Subsequently, a second micro embossing is impressed into the second coating on the second surface of the base material. Finally, a second layer of metal is vacuum deposited upon the second coating applied to the first layer of metal on the second surface of the base material.

In other embodiments, additional layers of micro embossed coatings that are metallized are likewise contemplated.

In certain embodiments both water soluble coatings and organic solvent soluble coatings can be utilized so as to provide flakes that are encapsulated in one of an organic or water soluble coatings. Such an encapsulated flake may be highly suitable for certain applications.

With respect to the film itself, the metal flake forming film assembly that is contemplated comprises a base material, a first coating, a first layer of vapor deposited metal, a second coating, and a second layer of vapor deposited metal. The base material has a first surface and a second surface. The first coating is applied to the first surface of the base material. The first coating is impressed with a first micro embossing. A first layer of vacuum deposited metal covers the first coating of the first surface of the base material and the micro embossing impressed thereinto. The second coating is applied to the first layer of vacuum deposited metal. The second coating has a second micro embossing impressed into the surface thereof. The second layer of vacuum deposited metal covers the second coating of the first surface of the base material and the micro embossing is impressed thereinto. In such a configuration, the successive placement of the second coating and the impressing of the second micro embossing into the surface of the second coating does not adversely affect or alter the first micro embossing impressed into the first coating on the first surface.

In a preferred embodiment, the base material comprises a polymer film, and, most preferably, a PET material which may or may not be treated (i.e., corona treated).

In a preferred embodiment, the coatings can be alternated so that encapsulated metal flakes can be created, wherein the flakes are encapsulated by either one of a water soluble coating and an organic soluble coating.

In another preferred embodiment, additional layers of coatings that are micro embossed and covered with a vacuum deposited layer of metal are likewise contemplated.

In another preferred embodiment, the second surface of the base material may likewise be coated with successive layers of coatings that are micro embossed and covered with a vacuum deposited layer of metal. In particular, such a configuration further includes a first coating applied to the second surface of the base material. This coating is then impressed with a first micro embossing. A first layer of vacuum deposited metal then covers the first coating of the second surface of the base material and the micro embossing impressed thereinto. Additionally, a second coating is positioned on the first layer of vacuum deposited metal on the second surface of the base material. The second coating likewise includes a second micro embossing impressed into the second coating on the second surface of the base material. As with the first micro embossed coating, a second layer of vacuum deposited metal covers the second coating of the second surface of the base material and the micro embossing impressed thereinto. As with the first surface micro embossings, the second micro embossing on the second surface of the base material does not adversely affect or alter the first micro embossing impressed into the first coating on the second surface. Additionally, the first micro embossing on the second surface of the base material does not adversely affect or alter the first or second micro embossing impressed into the first and second coatings, respectively on the first surface of the base material.

### BRIEF DESCRIPTION OF THE DRAWINGS

The disclosure will now be described with reference to the drawings wherein:

FIG. 1 of the drawings is a cross-sectional view of a first embodiment of a metal flake forming film assembly of the present disclosure showing in particular multiple metal flake forming layers on both sides of the base material;

FIG. 2 of the drawings is a cross-sectional view of a first metal flake layer which is a portion of the first embodiment of the metal flake forming assembly of the present invention; and

FIG. 3 of the drawings is a cross-sectional view of a second embodiment of a metal flake forming film assembly of the present disclosure showing multiple metal flake layers on both sides of a base material which flakes are encapsulated.

### DETAILED DESCRIPTION OF THE DISCLOSURE

While this invention is susceptible of embodiment in many different forms, there is shown in the drawings and described herein in detail a specific embodiment with the understanding that the present disclosure is to be considered as an exemplification and is not intended to be limited to the embodiment illustrated.

It will be understood that like or analogous elements and/or components, referred to herein, may be identified throughout the drawings by like reference characters. In addition, it will be understood that the drawings are merely schematic representations of the invention, and some of the components may have been distorted from actual scale for purposes of pictorial clarity.

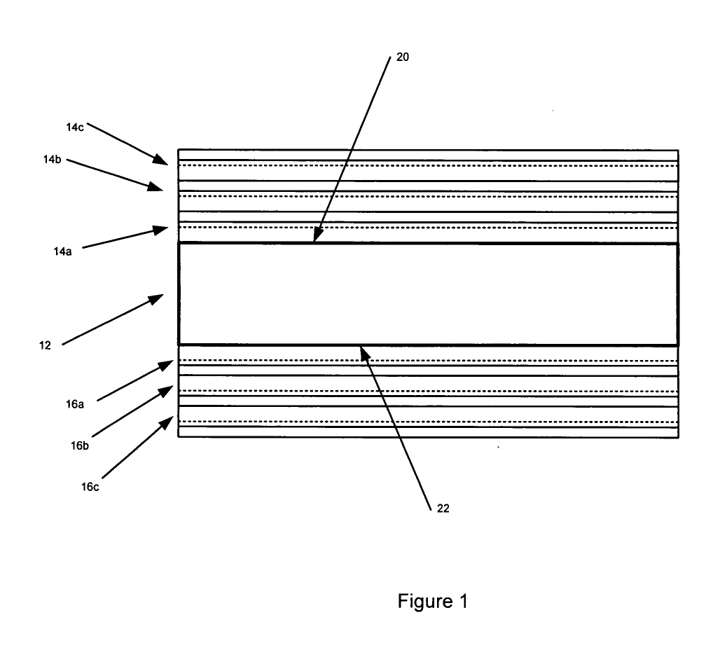

Referring now to the drawings and in particular to FIG. 1, the metal flake forming film assembly is shown generally at 10. The metal flake film assembly is used to create metal flakes of the type that are incorporated into various different products, such as automotive paints, nail polishes and the like. Of course, the disclosure and the metal flakes described herein are not limited to use in any particular application, and, any application is described for exemplary purposes solely without limitation.

So as to maximize the quantity of metal flake that can be produced and processed for a particular film, it has been found that multiple layers of vapor deposited metal can be sequentially applied to a film in a manner that does not degrade any underlying embossings.

With reference to FIG. 1, metal can be vacuum deposited onto either side of the base material 12. Specifically, as is shown in FIG. 1, the base material 12 includes a first surface 20 and a second surface 22. The base material preferably comprises a polymer film of suitable thickness. One example is a non corona treated PET material in a 48 gauge thickness. Of course, other polymers, both treated and non-treated are likewise contemplated.

The base material is shown to have a first upper metal flake layer 14a, second upper metal flake layer 14b, third upper metal flake layer 14c, first lower metal flake layer 16a, second lower metal flake layer 16b and third lower metal flake layer 16c. The metal flake layers are substantially identical in configuration. As a result, the first upper metal flake layer will be described with the understanding that the other upper and lower metal flake layers are each substantially identical.

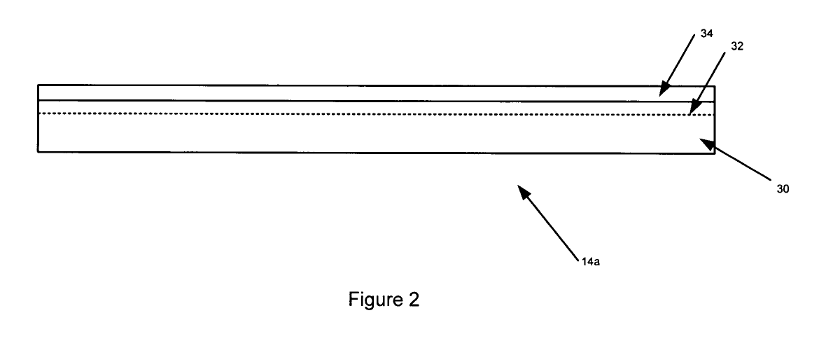

With reference to FIG. 2, first upper metal flake layer 14a is shown. The metal flake layer comprises first coating 30. The first coating 30 is applied to the first surface 20 of the base material 12 (FIG. 1). This coating may comprise a water soluble or a organic solvent soluble coating material (typically a polymer) that can be applied to and is compatible with the underlying base material and the metal that is utilized. The coating is typically applied in solution and then dried.

The coating is applied in a thickness that is sufficient to fill and level out the surface topography of the immediately preceding layer (in this case the first surface 20 of the base material 12, and to provide a smooth layer for receiving the impressing of the micro embossing. In certain embodiments, the coating is applied in two layers, wherein the first layer fills and levels the surface topography of the immediately preceding layer and the second layer smoothes out the upper surface of the first layer to prepare the coating for receiving the impressing of the micro embossing.

The coating is subjected to a micro embossing that is impressed into the surface thereof. This is represented by reference number 32 in FIG. 2. Typically, the coating is heated and a roller having a shim with micro embossing is impressed onto the surface of the coating under pressure so as to impress a micro embossing into the surface of the coating. The coating and the base material are then cooled. Once cooled, the base film and the coating are processed through a vacuum metal deposition station. In such a station, a metal or alloy 34 is vaporized and vacuum deposited onto the coating having the micro embossing. This micro embossing renders what is deemed a holographic effect.

The successive layers are substantially identical. Surprisingly, it has been found that when the coating is covered with a vacuum deposited layer of metal, the integrity of the coating is greatly enhanced. Subsequent coatings can be applied and impressed with a micro embossing without adversely affecting or degrading or otherwise altering the underlying coating or coatings or the underlying metallized layers. Thus, the process can be repeated with additional metal flake layers on top of metal flake layers. Additionally, the process can be repeated on both sides of the base material so as to render successive layers of upper metal flake layers and successive layers of lower metal flake layers.

It will be understood that the type of coatings can be varied so as to use both water soluble and organic solvent soluble materials (typically polymers). In certain embodiments both types of materials can be utilized. For example, certain metal flakes can be coated on either side with an organic soluble material and other layers can be formed with water soluble coatings. Later processing in a desired aqueous solution or organic solvent can release some of the flakes and dissolve certain of the coatings, while leaving other coatings intact so as to render metal flakes that are encapsulated in either one of a water soluble coating or an organic solvent soluble coating. Water soluble coatings are described in co-pending patent application entitled “Water Release Silver And Holographic Metal Flake And Method Of Manufacturing Metal Flake” the entire specification of which is incorporated by reference in its entirety.

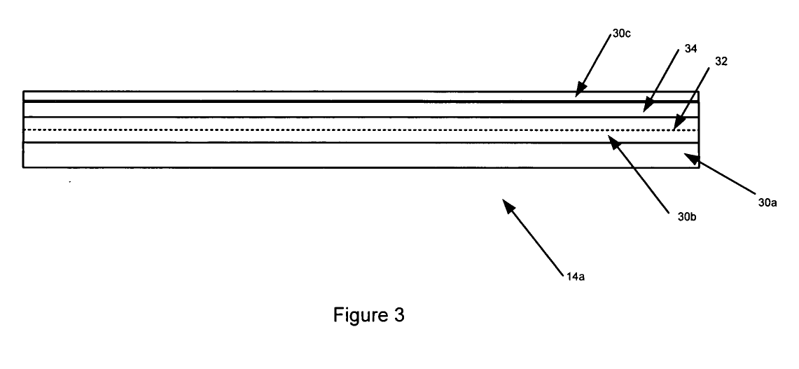

One such embodiment of an encapsulated multiple layer film is shown in FIG. 3. Specifically, FIG. 3 depicts adjoining metal flake layers of an embodiment wherein the flake is encapsulated. For example, the coating comprises a first coating layer 30a which is an organic solvent soluble coating and second coating layer 30b which is a water soluble coating. The embossing is then impressed into the second coating layer 30b, and the metallized layer 34 is vapor deposited thereupon. The subsequent coating layer 30c comprises a water soluble coating followed by an organic soluble coating. It will be understood that in such an application, when the film is introduced into an organic solvent, the organic soluble coating is dissolved breaking the metallized layer into metallized flakes that are coated in the water soluble coating (which remains unaffected by the organic solvent). Such a metallized flake having a water soluble coating can be introduced into an organic solvent based paint wherein the water soluble coating protects the underlying metal flakes.

In another embodiment, the coatings can be swapped, and metal flakes can be produced that are coated in an organic solvent. Such metallized flake having an organic solvent soluble coating can be introduced into, for example, a water based paint wherein the organic solvent soluble coating protects the underlying metal flakes.

It will also be understood that for certain metal flake layers, it may be desirable to omit the step of embossing. Such layers are processed and made in a similar manner, except that the step of impressing a micro embossing is skipped. In certain embodiments, the micro embossing of each of the successive metal flake layers may be identical. As such, when the film is introduced into a solvent, all of the coatings are dissolved and all of the metal flakes that are created are substantially identical. In other embodiments, different layers may comprise different micro embossing so that when the film is introduced into a solvent, a number of differently configured metal flakes are formed. It will be understood that after formation of metal flakes, it is difficult to sort or otherwise segregate the metal flakes. In certain instances, they may be separated by size and shape, but such manual separation is rather difficult.

Advantageously, it will be understood that with the present invention, a roll of film can be coated and metallized with, for example six or more layers (three on either side of the base material) as is shown in FIG. 1, which greatly increases the yield of metal flake that is produced from a single roll. In most conventional manufacturing methods for micro embossed metal flakes, a film may have a single side of the film which is coated and metallized. Thus, relative to such a roll of film, the yield of a roll made under the present disclosure increases the yield of a roll substantially without affecting the quality of the underlying flake. Such increased yield greatly reduces cost with respect to handling, shipping, transport and stripping.

Certain test examples were created following the disclosure and the methods disclosed therein. Each example is set forth below in detail. It will be understood that these are merely exemplary of the embodiments of the disclosure, and are not to be deemed limiting.

### Example 1

A PET base material was first provided in the form of a 48 gauge corona treated PET under the product name NanYa BH216. A first coating was applied. The coating was formulated as follows: 12.6 formula weight PB-588 available from Dianal America, Inc. of Pasadena, Tex. combined with 5.4 formula weight DER 661 available from Dow Chemical Company of Midland, Mich. in ethyl acetate. The PET was coated 1 gsm with 1 min of oven drying at a temperature of 70° C.

This coated PET base material was then micro-embossed with a rainbow shim at 2.5 feet/minute at a temperature of 65.5° C. Once the micro-embossing process was completed, the film was metallized to an optical density between 1.5 and 2.0. After metallization, a second coating was applied. It was identical to the first coating set forth above. A similar drying process followed. Once dried, the second coating was micro-embossed at the same speed and temperature as the first. Following micro-embossing, the second coating was metallized.

Prior to the production of flakes, the configuration of the first metallized layer was observed by viewing through the back side of the PET film. There was no visually observable change or degradation of the first micro-embossing due to the second coating process or the second metallization process.

Flakes were produced by placing a 4″×4″ square of film in an 11 dram vial. Subsequently, 15 ml of ethyl acetate was added to the vial and the vial was shaken manually for one minute. High quality embossed metal flakes were generated by the process.

### Example 2

A PET base material was first provided in the form of a 48 gauge corona treated PET under the product name NanYa BH216. A first coating was applied. The coating was formulated as follows: 5.7 formula weight of Kuraray Poval PVA-505 (80% partially hydrolyzed polyvinyl acetate) mixed with 0.9 formula weight of Cat-Floc 8799 Plus (Poly(Diallyldimethylammonium chloride) of MW<100K) from Nalco dissolved in water. The PET was coated 0.25 gsm with 1 min of oven drying at a temperature of 70° C.

Over this first coating, a second coating was applied. The second coating was formulated as follows: 12.6 formula weight PB-588 available from Dianal America, Inc. of Pasadena, Tex. combined with 5.4 formula weight DER 661 available from Dow Chemical Company of Midland, Mich. in ethyl acetate. The second coating was oven dried for 1 minute at a temperature of 70° C. It was observed that the second coating did not degrade or otherwise adversely affect the underlying material.

The second coating was micro-embossed with a rainbow shim at 2.5 feet per minute at a temperature of 150° C. The micro-embossed surface was then metallized to an optical density of 1.5 to 2.0.

A coating was applied to the metallized layer. This third coating was formulated as follows: 12.6 formula weight PB-588 available from Dianal America, Inc. of Pasadena, Tex. combined with 5.4 formula weight DER 661 available from Dow Chemical Company of Midland, Mich. in ethyl acetate. The third coating was oven dried for 1 minute at a temperature of 70° C. It was observed that the metallized layer was not disturbed or otherwise adversely affected by the third coating.

To make flakes, a 4″×4″ square of film was placed in an 11 dram vial. Subsequently, 15 ml of water at ambient temperature was added. Finally, the vial was shaken manually for two minutes. High quality embossed metal flakes were generated by the process. These flakes were encapsulated within the organic soluble coatings.

The foregoing description merely explains and illustrates the invention and the invention is not limited thereto except insofar as the appended claims are so limited, as those skilled in the art who have the disclosure before them will be able to make modifications without departing from the scope of the invention.

What is claimed is:

1. A method of manufacturing metal flake film comprising the steps of:
providing a base material having a first surface and a second surface;
applying a first coating to the first surface of the base material;
impressing a first micro embossing into the first coating;
vacuum depositing a first layer of metal upon the first coating applied to the first surface having the micro embossing;
applying a second coating upon the first layer of metal;
impressing a second micro embossing into the second coating; and
vacuum depositing a second layer of metal upon the second coating applied to the first layer of metal.

2. The method of manufacturing metal flake film of claim 1 wherein the steps of coating and impressing the second micro embossing leaves the first micro embossing substantially unaffected and unaltered.

3. The method of manufacturing metal flake film of claim 1
repeating, at least once, the steps of applying, impressing and vacuum depositing to, in turn, form at least one additional layer of coating and metal.

4. The method of manufacturing metal flake film of claim 1 further comprising the steps of:
applying a first coating to the second surface of the base material;
impressing a micro embossing into the first coating on the second surface of the base material; and
vacuum depositing a first layer of metal upon the first coating applied to the second surface having the micro embossing.

5. The method of manufacturing metal flake film of claim 4 further comprising the steps of:
applying a second coating to the first layer of metal on the second surface of the base material;
impressing a second micro embossing into the second coating on the second surface of the base material; and
vacuum depositing a second layer of metal upon the second coating applied to the first layer of metal on the second surface of the base material.

6. The method of manufacturing metal flake film of claim 5 further comprising the steps of:
repeating, at least once, the steps of applying, impressing and vacuum depositing to, in turn, form at least one additional layer of coating and metal.

7. The method of manufacturing metal flake film of claim 1 further comprising the steps of:
utilizing a water soluble coating for one of the first and second coatings; and
utilizing a organic solvent soluble coating for one of the first and second coatings, to, in turn, render metal flakes which are encased in one of a water soluble or organic solvent soluble coatings.

8. A metal flake forming film assembly comprising:
a base material having a first surface and a second surface;
a first coating applied to the first surface of the base material;
a first micro embossing impressed into the first coating on the first surface of the base material;
a first layer of vacuum deposited metal covering the first coating of the first surface of the base material and the micro embossing impressed thereinto;
a second coating applied to the first layer of vacuum deposited metal;
a second micro embossing impressed into the second coating on the first surface of the base material;
a second layer of vacuum deposited metal covering the second coating of the first surface of the base material and the micro embossing impressed thereinto,
wherein the second micro embossing does not adversely affect or alter the first micro embossing impressed into the first coating on the first surface.

9. The metal flake forming film assembly of claim 8 wherein the base material comprises a polymer film.

10. The metal flake forming film assembly of claim 9 wherein the base material comprises a PET film.

11. The metal flake forming film assembly of claim 8 wherein one of the first coating and the second coating comprises a water soluble solvent and the other of the first coating and the second coating comprises an organic soluble solvent.

12. The metal flake forming film assembly of claim 8 further comprising:
a least one additional coating having at least one additional micro embossing; and
at least one additional layer of vacuum deposited metal covering the at least one additional coating.

13. The metal flake forming film assembly of claim 8 further comprising:
a first coating applied to the second surface of the base material;
a first micro embossing impressed into the first coating on the second surface of the base material;
a first layer of vacuum deposited metal covering the first coating of the second surface of the base material and the micro embossing impressed thereinto;
a second coating applied to the first layer of vacuum deposited metal on the second surface of the base material;
a second micro embossing impressed into the second coating on the second surface of the base material;
a second layer of vacuum deposited metal covering the second coating of the second surface of the base material and the micro embossing impressed thereinto,
wherein the second micro embossing on the second surface of the base material does not adversely affect or alter the first micro embossing impressed into the first coating on the second surface and wherein the first micro embossing on the second surface of the base material does not adversely affect or alter the first or second micro embossing impressed into the first and second coatings, respectively on the first surface of the base material.
